(19) United States
(12) Patent Application Publication
(10) Pub. No.: US 2019/0183058 A1
(43) Pub. Date: Jun. 20, 2019

(54) INSULATED FLOWER VESSEL DEVICE AND METHOD

(71) Applicant: Etaf Shaban, Hutchinson, KS (US)

(72) Inventor: Etaf Shaban, Hutchinson, KS (US)

(21) Appl. No.: 16/216,817

(22) Filed: Dec. 11, 2018

Related U.S. Application Data
(60) Provisional application No. 62/607,747, filed on Dec. 19, 2017.

(51) Int. Cl. A01G 5/06; A47G 7/06; B65D 85/50; B65D 81/38

(52) U.S. Cl. CPC A01G 5/06; B65D 81/3841; B65D 85/505; A47G 7/06

(57) ABSTRACT

An insulated flower vessel includes a conical-cylindrical outer body having a first-closed-bottom configured to be terminated at a top rim with a conical-cylindrical inner body having a second-closed-bottom defining an internal volume. The conical-cylindrical outer body and the conical-cylindrical inner body are integral with one another and are configured to have a volumetric insulating space between the conical-cylindrical outer body and the conical-cylindrical inner body such that insulation means can be realized to resist heat movement into and out of said insulated flower vessel. The insulated flower vessel is useful for extending longevity of the fresh cut flowers.

### CROSS-REFERENCE TO RELATED APPLICATION(S)

The present application is related to and claims priority to U.S. Provisional Patent Application No. 62/607,747 filed Dec. 19, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### Technical Field

The present invention relates generally to the field of receptacles of existing art and more specifically relates to vases.

### Related Art

Many people like to cut and display flowers in water. The conventional way is by either replacing cold tap water frequently or maintain the coldness of the water while the vase sits on a table, counter, etc., is to add ice. This method, although effective, is messy because ice must be added frequently, and may drip on the table or counter top. Also, the ice may be quite bulky and cumbersome which may cause the arrangement to become distorted. Placing fresh cut flowers in a vase often results in the flowers dying within a few days. It is frustrating for consumers who spend a good deal of money on flowers to have them die so quickly. This short lifespan can discourage individuals from wanting to purchase flowers for other than special occasions. What is needed is a convenient, compact, attractive, immediately effective, and mess-free means for maintaining water at the refrigerator temperature over an extended period to keep flowers fresh and promote longevity.

U.S. Pat. No. 650,614 to Alexander Roeseler relates to a flower-pot. The described flower-pot includes flower pots and vases and the like; and it consists in providing these receptacles with double walls inclosing a stagnant layer of air and in providing the bottoms of the same with inwardly and upwardly extending tubes or pipes instead of the ordinary orifices. The pot or vase is provided with double walls, closed at the top by an annular ring and open at the bottom, which closes up the inner wall only. The pot itself is provided with feet, any desired number of which may be employed, and inwardly-extending tubes are arranged in the said bottom, so that all the water fed to the contents of the pot will not at once escape, as is the case with the ordinary flowerpots; but a certain quantity will remain, which may then be absorbed by the earth in case the flower or other plant in the pot may at any time not have been watered by inadvertence or from any other cause. The tubes constitute overflow-pipes.

### SUMMARY OF THE INVENTION

In view of the foregoing disadvantages inherent in the known receptacles art, the present disclosure provides a novel insulated flower vessel device and method. The general purpose of the present disclosure, which will be described subsequently in greater detail, is to provide an effective and efficient insulated flower vessel device and method.

An insulated flower vessel for extending longevity of fresh cut flowers is disclosed herein. The insulated flower vessel for extending longevity of fresh cut flowers preferably includes a conical-cylindrical outer body having a first-closed-bottom configured to be terminated at a top rim with a conical-cylindrical inner body having a second-closed-bottom defining an internal volume. In preferred embodiments the conical-cylindrical outer body and the conical-cylindrical inner body are integral with one another and are configured to have a volumetric insulating space between the conical-cylindrical outer body and the conical-cylindrical inner body such that insulation means can be realized to resist heat movement into and out of said insulated flower vessel for extending longevity of the fresh cut flowers.

According to another embodiment, a method of use for an insulated flower vessel for extending longevity of fresh cut flowers is also disclosed herein. The method of use for an insulated flower vessel for extending longevity of fresh cut flowers includes a first step, providing an insulated flower vessel for extending longevity of fresh cut flowers comprising; a conical-cylindrical outer body having a first-closed-bottom configured to be terminated at a top rim with a conical-cylindrical inner body having a second-closed-bottom defining an internal volume and wherein said conical-cylindrical outer body and the conical-cylindrical inner body are integral with one another and are configured to have a volumetric insulating space between the conical-cylindrical outer body and the conical-cylindrical inner body such that insulation means can be realized to resist heat movement into and out of the insulated flower vessel for extending longevity of the fresh cut flowers; second step, filling the internal volume with refrigerated water; third step, submersing the stems of fresh cut flowers into the water within the internal volume; forth step, displaying a floral arrangement in the insulated flower vessel in a preferred location; and a fifth step, disposing contents held in the vessel; and a sixth step, storing vessel in a refrigerated environment.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an insulated flower vessel device, constructed and operative according to the teachings of the present disclosure.

FIG. 1 is a perspective view of the insulated flower vessel during an ‘in-use’ condition, according to an embodiment of the disclosure.

FIG. 2 is a front cut-away view of the insulated flower vessel of FIG. 1, according to an embodiment of the present disclosure.

FIG. 3 is a perspective view of the insulated flower vessel of FIG. 1, according to an embodiment of the present disclosure.

FIG. 4 is a front cut-away view of the insulated flower vessel of FIG. 1, according to an embodiment of the present disclosure.

FIG. 5 is a flow diagram illustrating a method of use for the insulated flower vessel, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a receptacle and more particularly to an insulated flower vessel device as used to improve the longevity of cut flowers

Generally, the insulated flower vase of the present invention provides an insulated vase designed to extend the life of fresh cut flowers to several weeks. It offers a functionally decorative flower vase that keeps the water inside cooler to maintain freshness.

Insulated Vase is designed to house and display flowers while extending the life of the flowers. The invention is comprised of an insulated vase made of stainless steel that is double wall and vacuum insulated. The vase may also be made from double wall plastic or combinations of other composites and alloys. The bottom and side walls of the vase are insulated to keep the water inside cool. The vase may be decorated and designed in all shapes, sizes and colors. It may also be personalized and customized.

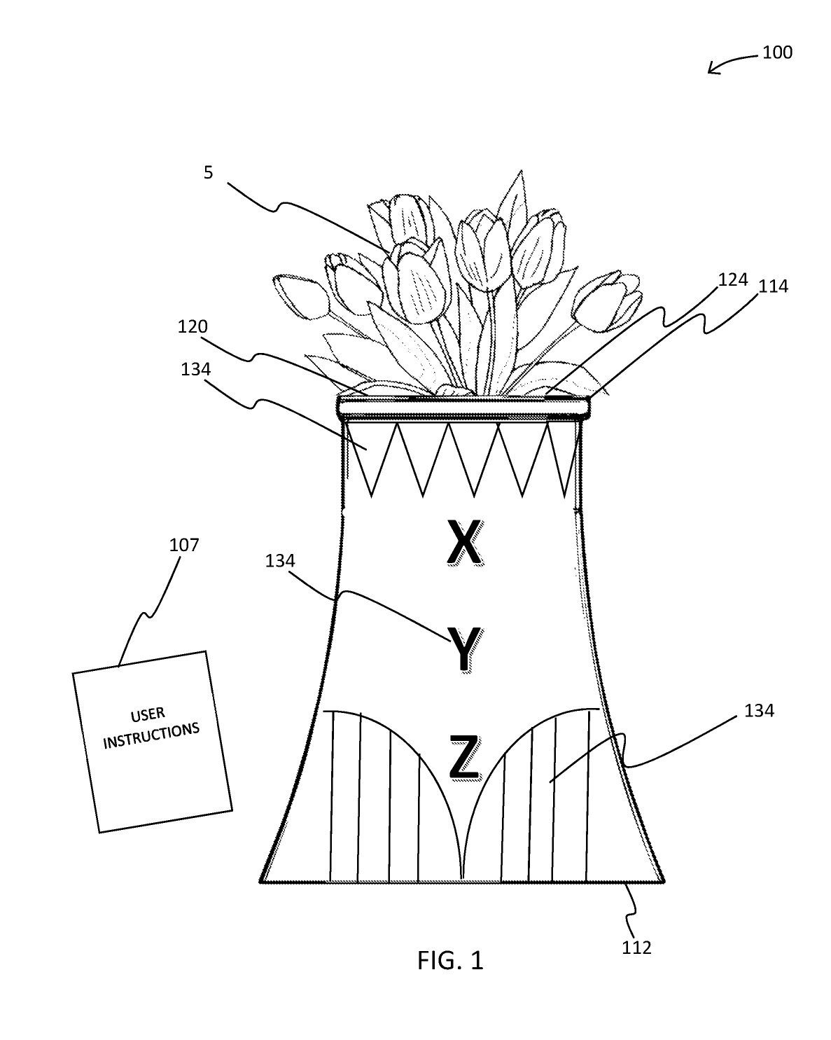

Referring now more specifically to the drawings by numerals of reference, there is shown in FIGS. 1-4, various views of an insulated flower vessel 100.

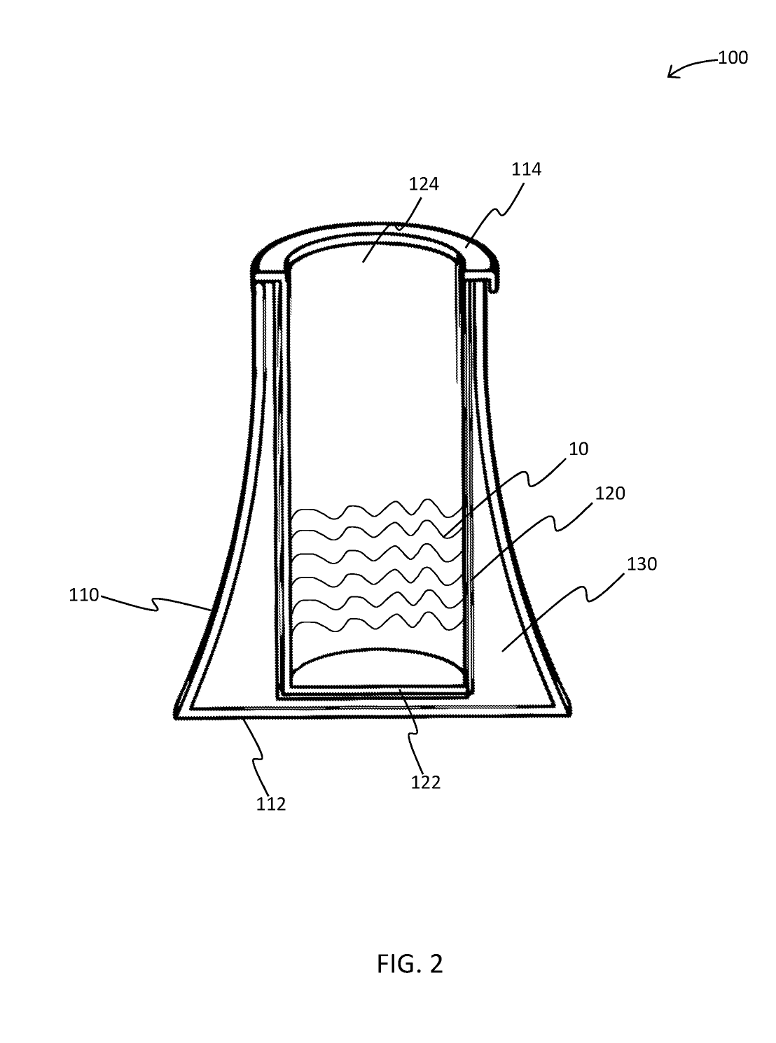

FIG. 1 shows an insulated flower vessel 100 during an ‘in-use’ condition 50, according to an embodiment of the present disclosure. Here, the insulated flower vessel 100 may be beneficial for use by a user 40 to extend longevity of fresh cut flowers 5. As illustrated, the insulated flower vessel 100 may include a conical-cylindrical outer body 110 having a first-closed-bottom 112 configured to be terminated at a top rim 114. A conical-cylindrical inner body 120 having a second-closed-bottom 122 defines an internal volume 124. The conical-cylindrical outer body 110 and the conical-cylindrical inner body 120 are integral with one another and are configured to have a volumetric insulating space 130 between the conical-cylindrical outer body 110 and the conical-cylindrical inner body 120 as will be detailed in the following FIGS. 2-4. The volumetric insulating space 130 may be arranged such that an insulation means may be provided to resist heat movement into and out of the insulated flower vessel 100. By providing an insulating means, the water 10 held within the vessel 100 remains colder for a longer period, extending longevity of the fresh cut flowers 5.

In an embodiment of the present disclosure the volumetric insulating space 130 may be a sealed vacuum 138. Additionally, the bottom diameter of the outer body 110 may be significantly larger than the diameter of the top rim 114. Although other outer body 110 configurations may also be envisioned.

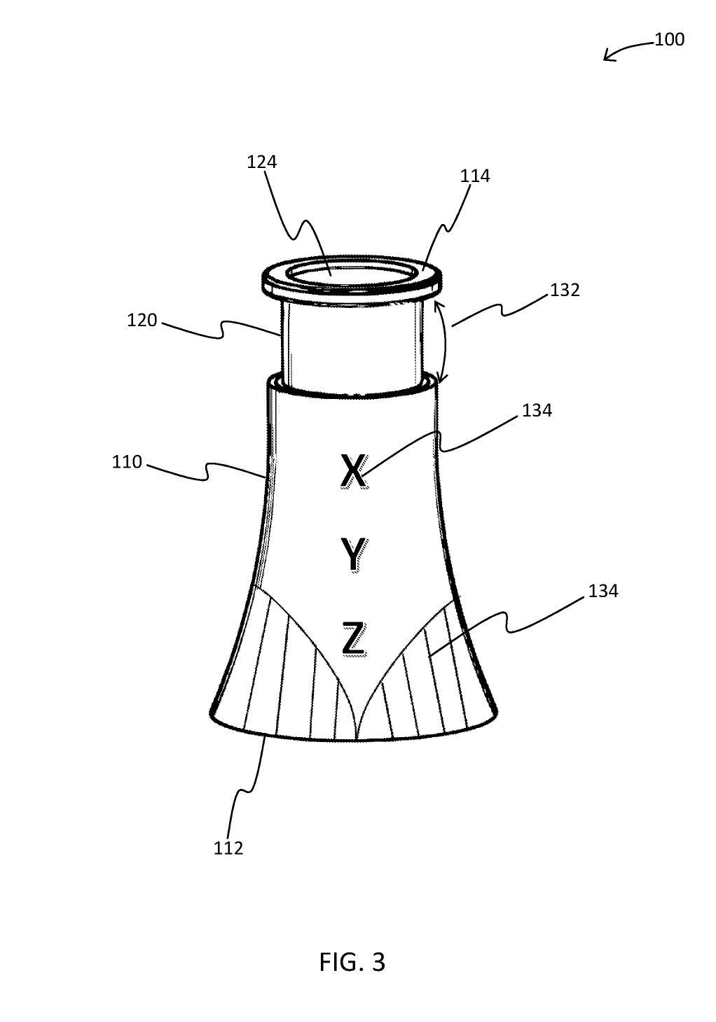

In yet another embodiment the conical-cylindrical outer body 110 may be removably couplable to the conical-cylindrical inner body 120 as shown in FIGS. 3 & 4. Furthermore, the exterior of the conical-cylindrical outer body 110 may include functional decorative indicia 134 useful for promotional gifts, holidays or special occasions.

According to one embodiment of the insulated flower vessel 100 the conical-cylindrical outer body 110 and the conical-cylindrical inner body 120 may be made of a combination of metal alloy and a composite material. Further as shown in FIG. 1, the insulated flower vessel 100 stands vertically during use and the top rim 114 is on a plane higher than the bottom. It may also be constructed with materials such that the device can be stored in a refrigerator or freezer during pre-use. The insulated flower vessel 100 may also be configured to be dishwasher-safe for cleaning. Upon reading this specification, it should be appreciated that, under appropriate circumstances, considering such issues as user preferences, design preference, structural requirements, marketing preferences, cost, available materials, technological advances, etc., other inner/outer body 110 arrangements such as, for example, larger in size, tall and cylindrical, decorative shapes, etc., may be sufficient.

According to one embodiment, the insulated flower vessel 100 may be arranged as a kit 105. In particular, the insulated flower vessel 100 may further include a set of instructions 107. The instructions 107 may detail functional relationships in relation to the structure of the insulated flower vessel 100 such that the insulated flower vessel 100 can be used, maintained, or the like, in a preferred manner.

FIG. 2 is a front cut-away view of the insulated flower vessel 100 of FIG. 1, according to an embodiment of the present disclosure. As above, the insulated flower vessel 100 may include a conical-cylindrical outer body 110 having a first closed-bottom 112 configured to be terminated at a top rim 114 with a conical-cylindrical inner body 120 having a second-closed-bottom 122 defining an internal volume 124.

In an embodiment of the present disclosure the conical-cylindrical outer body 110 and the conical-cylindrical inner body 120 as shown are integral with one another and may be configured to have a volumetric insulating space 130. The volumetric insulating space 130 between the conical-cylindrical outer body 110 and the conical-cylindrical inner body 120 may be such that insulation means can be realized to resist heat movement into and out of the insulated flower vessel 100 for extending longevity of the fresh cut flowers 5. In one embodiment volumetric insulating space 130 may be a sealed vacuum.

Further the bottom diameter of the outer body 110 may be significantly larger than the diameter of the top rim 114 as shown, and the device stands vertically during use. However other outer body shapes may be incorporated. Additionally, the conical-cylindrical outer body 110 and the conical-cylindrical inner body 120 may be made of glass, metal alloy, composite material or any suitable combination thereof. Advantageously, the material(s) used in the construction of the insulated flower vessel 100 may be stored in freezer pre-use and dishwasher-safe for cleaning.

FIG. 3 is a perspective view of the insulated flower vessel 100 of FIG. 1, according to an embodiment of the present disclosure. As shown the conical-cylindrical outer body 110 is removably couplable to the conical-cylindrical inner body 120. According to an embodiment the insulated flower vessel 100 the top rim 114 of the conical-cylindrical inner body 120 may include a treaded collar removably couplable 132 to a treaded portion on the upper portion of the outer body 110. Other embodiments may be removably couplable 132 via a friction coupling, snap lock coupling or other coupling common to the art. Sill other embodiments of the insulated flower vessel 100 although not illustrated, may include a conical-cylindrical inner body 120 removably couplable 132 and may further comprise a slip-fit conical-cylindrical inner body 120, having a top rim flange nestable or restable to the top rim 114 of the conical-cylindrical outer body 110. These configurations provide a user an easier means of water 10 and/or flower 5 replacement and disposal when the use of a larger heavier insulated flower vessel 100 may be desired.

According to still another embodiment, the exterior of the conical-cylindrical outer body includes functional decorative indicia 134. The functional decorative indicia 134 may include but are not limited to for example digital print, paint, embossing and magnetic indicia. Further the functional decorative indicia 134 may be useful for promotional gifts, holidays or special occasions. It should be noted that the functional decorative indicia 134 may also be inter-changeable and/or removable in certain embodiment configurations.

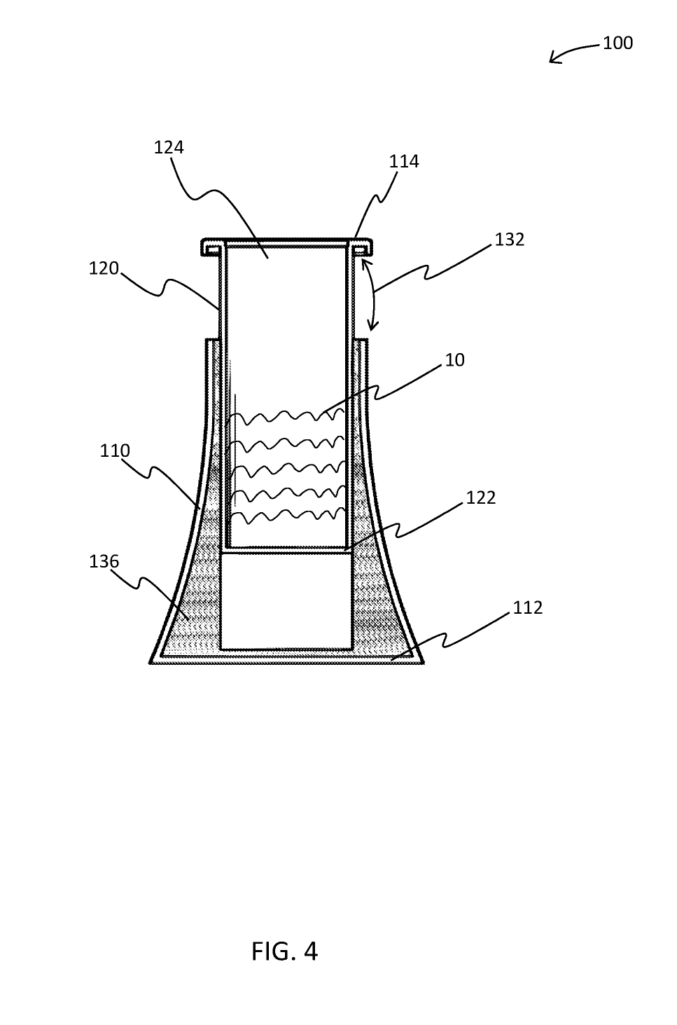

FIG. 4 is a front cut-away view of the insulated flower vessel 100 of FIG. 1, according to an embodiment of the present disclosure. As above the insulated flower vessel 100 may include a conical-cylindrical outer body 110 having a first closed-bottom 112 configured to be terminated at a top rim 114 with a conical-cylindrical inner body 120 having a second-closed-bottom 122 defining an internal volume 124. Further as illustrated in FIG. 4 the insulated flower vessel 100 the top rim 114 may include a treaded collar removably couplable 132 to a treaded portion on the upper portion of the outer body 110.

The volumetric insulating space 130 shown in FIG. 2 may be arranged such that an insulation means may be provided to resist heat movement into and out of the insulated flower vessel 100. By providing an insulating means, the water 10 held within the vessel 100 remains colder for a longer period, extending longevity of the fresh cut flowers 5. According to an embodiment of the insulated flower vessel 100 the volumetric insulating space 130 between the conical-cylindrical outer body 110 and the conical-cylindrical inner body 120 is partially evacuated of air, creating a near-vacuum which significantly reduces heat transfer by convection. Conversely the volumetric insulating space 130 between the conical-cylindrical outer body 110 and the conical-cylindrical inner body 120 is partially evacuated of air, creating a near-vacuum which significantly reduces heat transfer by conduction. Those with ordinary skill in the art will now appreciate that upon reading this specification and by their understanding the art, the volumetric insulating space 130 between the conical-cylindrical outer body 110 and the conical-cylindrical inner body 120 is partially evacuated of air, although other methods of insulating will be understood by those knowledgeable in such art. Other examples may include but not be limited to filling the volumetric insulating space 130 with insulating foam 136 as illustrated, re-freezable gel or cold water 10.

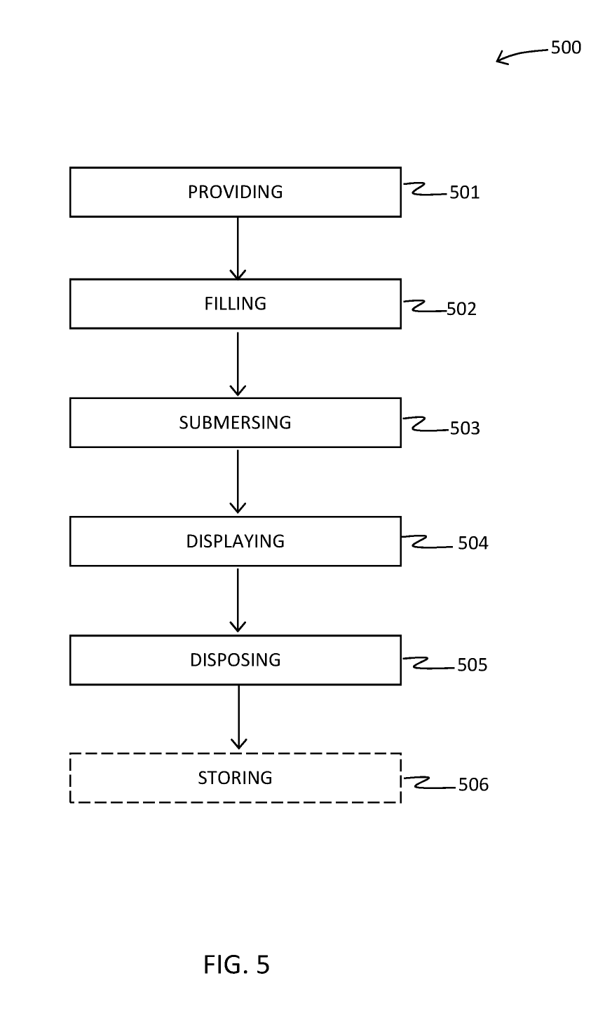

FIG. 5 is a flow diagram illustrating a method for using 500 the insulated flower vessel 100, according to an embodiment of the present disclosure. In particular, the method for use 500 of the insulated flower vessel 100 may include one or more components or features of the insulated flower vessel 100 as described above. As illustrated, the method for use 500 of an insulated flower vessel 100 may include the steps of: step one 501, providing an insulated flower vessel 100 for extending longevity of fresh cut flowers comprising; a conical-cylindrical outer body 110 having a first-closed-bottom 112 configured to be terminated at a top rim 114 with a conical-cylindrical inner body 120 having a second-closed-bottom 122 defining an internal volume 124; and wherein said conical-cylindrical outer body 110 and the conical-cylindrical inner body 120 are integral with one another and are configured to have a volumetric insulating space 130 between the conical-cylindrical outer body 110 and the conical-cylindrical inner body 120 such that insulation means can be realized to resist heat movement into and out of said insulated flower vessel 100 for extending longevity of the fresh cut flowers 5; step two 502, filling the internal volume 124 with refrigerated water 10. Under certain circumstances a user may find it advantageous to add a plant food additive typically included with the purchase of fresh cut flowers into the water as well; step three 503, submersing the stems of fresh cut flowers into the water within the internal volume. This step may include trimming the stems and positioning of the fresh cut flowers 5 in a manner that is commonly referred to as a floral arrangement as shown in FIG.1. As disclosed in FIG. 3 the insulated flower vessel 100 may be configured such that the top rim 114 of the conical-cylindrical inner body 120 may include a treaded collar removably couplable 132 to a treaded portion on the upper portion of the outer body 110. This configuration may prove especially useful when changing the water 10 held within the internal volume 124 of the insulated flower vessel 100. The need to move the conical-cylindrical outer body 130 of the insulated flower vessel 100 when using a larger and/or highly decretive insulated flower vessel 100 may be undesirable; step four 504, displaying a floral arrangement in the preferred location on a planar surface such that the device stands vertically during use. As mentioned above in FIG. 1 the insulated flower vessel 100 may include functional decorative indicia 134 which may be useful for promotional gifts, holidays or special occasions. Further, as noted above, the functional decorative indicia 134 may also be inter-changeable and/or removable in certain embodiment configurations. In such embodiments the user 40 may select and apply the functional decorative indicia 134 that is most appropriate for an occasion; step five 505, disposing contents held in the insulated flower vessel 100. When the floral arrangement displayed in the insulated flower vessel 100 are no longer desired the user 40 may then dispose of the fresh cut flowers 5. When using an embodiment including the functional decorative indicia 134 that may also be inter-changeable and/or removable the user 40 may further wish to remove the functional decorative indicia 134; step six 506, storing the insulated flower vessel 100. As shown in FIGS. 1 & 2 the insulated flower vessel 100 may also be configured to be dishwasher-safe for cleaning. These materials may be made of glass or a combination of metal alloy and/or a composite material. Advantageously, the material(s) used in the construction of the insulated flower vessel 100 may be stored in dishwasher-safe for cleaning. Accordingly, in an embodiment as disclosed in FIG. 4 the insulated flower vessel 100 may include filling the volumetric insulating space 130 with insulating foam, re-freezable gel or cold water and may be stored in a freezer or refrigerated environment during pre-use.

It should be noted that step 506 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for insulated flower vessel are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An insulated flower vessel for extending longevity of fresh cut flowers, the device comprising:
a conical-cylindrical outer body having a first-closed-bottom configured to be terminated at a top rim with
a conical-cylindrical inner body having a second-closed-bottom defining an internal volume; and
wherein said conical-cylindrical outer body and said conical-cylindrical inner body are integral with one another and are configured to have a volumetric insulating space between the conical-cylindrical outer body and the conical-cylindrical inner body such that insulation means can be realized to resist heat movement into and out of said insulated flower vessel for extending longevity of the fresh cut flowers.

2. The device of claim 1, wherein the volumetric insulating space is a sealed vacuum.

3. The device of claim 1, wherein the volumetric insulating space is filled with insulating foam.

4. The device of claim 1, wherein the volumetric insulating space is filled with re-freezable gel.

5. The device of claim 1, wherein the bottom diameter of the outer body is significantly larger than the diameter of the top.

6. The device of claim 1, wherein the conical-cylindrical outer body is removably couplable to the conical-cylindrical inner body.

7. The device of claim 1, wherein the exterior of the conical-cylindrical outer body includes functional decorative indicia.

8. The device of claim 1, wherein the conical-cylindrical outer body and said conical-cylindrical inner body comprise metal alloy.

9. The device of claim 1, wherein the conical-cylindrical outer body and said conical-cylindrical inner body are made of a composite material.

10. The device of claim 1, wherein the conical-cylindrical outer body and said conical-cylindrical inner body are made of a combination of metal alloy and a composite material.

11. The device of claim 1, wherein the device stands vertically during use.

12. The device of claim 1, wherein the top rim is on a plane higher than bottom when in use.

13. The device of claim 1, wherein the device can be stored in freezer pre-use.

14. The device of claim 1, wherein the volumetric insulating space between the conical-cylindrical outer body and said conical-cylindrical inner body is partially evacuated of air, creating a near-vacuum which significantly reduces heat transfer by conduction.

15. The device of claim 1, wherein the volumetric insulating space between the conical-cylindrical outer body and said conical-cylindrical inner body is partially evacuated of air, creating a near-vacuum which significantly reduces heat transfer by convection.

16. An insulated flower vessel for extending longevity of fresh cut flowers, the device comprising: a conical-cylindrical outer body having a first-closed-bottom configured to be terminated at a top rim with
a conical-cylindrical inner body having a second-closed-bottom defining an internal volume; and
wherein said conical-cylindrical outer body and said conical-cylindrical inner body are integral with one another and are configured to have a volumetric insulating space between the conical-cylindrical outer body and the conical-cylindrical inner body such that insulation means can be realized to resist heat movement into and out of said insulated flower vessel for extending longevity of the fresh cut flowers;
wherein the volumetric insulating space is a sealed vacuum;
wherein the bottom diameter of the outer body is significantly larger than the diameter of the top;
wherein the conical-cylindrical outer body is removably couplable to the conical-cylindrical inner body;
wherein the exterior of the conical-cylindrical outer body includes functional decorative indicia;
wherein the conical-cylindrical outer body and said conical-cylindrical inner body are made of a combination of metal alloy and a composite material;
wherein the device stands vertically during use;
wherein the top rim is on a plane higher than bottom when in use;
wherein the device can be stored in freezer pre-use; and
wherein the insulated flower vessel is dishwasher-safe for cleaning.

17. The device of claim 16, further comprising set of instructions; and
wherein the device is arranged as a kit.

18. A method of use for an insulated flower vessel for extending longevity of fresh cut flowers, the method comprising the steps of:
providing an insulated flower vessel for extending longevity of fresh cut flowers comprising; a conical-cylindrical outer body having a first-closed-bottom configured to be terminated at a top rim with a conical-cylindrical inner body having a second-closed-bottom defining an internal volume; and wherein said conical-cylindrical outer body and said conical-cylindrical inner body are integral with one another and are configured to have a volumetric insulating space between the conical-cylindrical outer body and the conical-cylindrical inner body such that insulation means can be realized to resist heat movement into and out of said insulated flower vessel for extending longevity of the fresh cut flowers;
filling the internal volume with refrigerated water;
submersing the stems of fresh cut flowers into the water within the internal volume;
displaying a floral arrangement in the insulated flower vessel in a preferred location; and
disposing contents held in the vessel.

19. The method of claim 18, further comprising the step of
storing vessel in a refrigerated environment.
